(19) United States
(12) Patent Application Publication
(10) Pub. No.: US 2007/0256478 A1
(43) Pub. Date: Nov. 8, 2007

(54) Apparatus and method for measuring cavity leakage

(76) Inventors: C. Thomas Guadagnola, (US); Sergio Bartolini, (US)

Correspondence Address: C. THOMAS GUADAGNOLA, 1547 VISTA GRANDE ROAD, EL CAJON, CA, 92019, US

(21) Appl. No.: 11/416,601

(22) Filed: May 4, 2006

(51) Int. Cl. G01M 3/04

(52) U.S. Cl. 73/40

(57) ABSTRACT

A leak detection apparatus and method for testing a sealed cavity, but most readily suitable for leakage testing of the cylinder heads of internal combustion engines. The cavity is pressurized either positively or negatively with a probe. The probe is connected to a computer system or control unit containing pressure-sensing devices that measure the inlet and outlet pressures of an orifice of known geometry and dimensions. The cavity leak rate is a function of the orifice geometry and dimensions, the orifice inlet and outlet pressures, the ambient temperature, and the ambient pressure. The computer system determines the leakage rate and documents the test results in both printed and electronic formats. The apparatus can be used on an assembled engine or on individual cylinder heads mounted to a test station.

### PRIORITY FILING

This application is claiming the filing date of May 2, 2005 of provisional patent application Ser. No. 60/677,105.

### BACKGROUND

This disclosed apparatus relates to a new and useful leak detection system for a sealed cavity, more specifically to the discovery and recording of fluid leaks found in cylinder heads of internal combustion engines, but can foreseeably be used in testing any pressure vessel where it is desirable to quantify leakage.

In many industries, there are cavities that must be sealed to minimize fluid leakage. The fluid may be liquid or gaseous. Turbines, reciprocal pumps, turbo-chargers, super-chargers and internal combustion engines are some typical examples of such cavities. The cylinder head of an internal combustion engine is probably the most prevalent instance and so will be addressed in detail.

The cylinder head of an internal combustion engine has intake valves and exhaust valves that form a metal-to-metal seal that creates the sealed cavity. Unfortunately these seals are sometimes imperfect causing leakage. Likewise, a fully assembled internal combustion engine has intake valves, exhaust valves, head gaskets, piston rings, and possibly imperfections, such as cracks in the engine components themselves, which create a similar imperfect cavity seal. Even when cylinder heads are machined with the best equipment available today, these metal-to-metal seals are commonly imperfect and prone to excessive leakage.

Since it is common that the cylinder head machining is performed at a location remote from the engine assembly location or vehicle installation location it is important to find the presence of unacceptable cylinder head leakage before the engine is assembled and installed, due to the expense and effort required to remedy the problem. Often, when unacceptable leakage is found, it is not known whether the leakage is due to the machining process, the assembly process, or other factors.

It is important that the cylinder leakage in an assembled engine be low to ensure high output power and efficiency. It is important to have accurate measurements of engine leakage because this may indicate that engine failure is imminent thus preventing the damage of an expensive engine.

Currently one of the most common methods of determining whether or not a cylinder head leaks is to apply a negative pressure, commonly called a vacuum, to the cylinder head intake port and exhaust port. An analog vacuum gauge indicates the level of vacuum drawn. This method will detect leakage, but accuracy and repeatability are poor, it will not quantify the leakage rate to verify whether it is within acceptable limits, and it does not provide a printed, electronic or other data report of the test results.

Another method of testing an assembled engine is to apply a positive pressure to each cylinder individually, usually to about 80 psi, while all of the valves of the cylinder under test are closed and while preventing the engine from rotating. If the cylinder maintains a predetermined pressure for a required time duration, the cylinder leakage is acceptable, otherwise it is unacceptable. Due to the high positive pressure used, it is often difficult and potentially dangerous to prevent the engine from rotating. Once again, the test accuracy and repeatability are poor, leakage cannot be quantified and there is no data report of the test results. There is a need for a device that measures leakage rate and provides accurate results, consistent results, repeatable results and data reports. It is also desirable that the leakage rate measurements of an assembled engine can be performed at low or negative pressures so that the engine can be safely and easily secured.

### SUMMARY OF THE INVENTION

It is the primary object of this invention to provide a method and apparatus for measuring fluid leakage in a sealed cavity such as an internal combustion engine cylinder head or assembled engine. A further objective is to have an apparatus which provides for the testing of cylinder heads on assembled engines or on a test bench.

Another object of the invention is to utilize a variety of fluid pressures, ranging from positive pressures to negative pressures, commonly called a vacuum, to test for leakage and still maintain consistent and accurate results.

Another object of the invention is to provide a seal for otherwise open cavities.

Still yet another object of the invention is to use an orifice of known geometry and dimensions as part of a measurement system to determine the leakage rate.

An even further object of the invention is to provide visual, printed, and electronically stored test results indicating the leakage rate for a number of sealed cavities.

The preferred embodiment of the apparatus includes a probe that either positively or negatively pressurizes the sealed cavity or cylinder head. In an assembled engine, the cavity is sealed by locking or securing the crankshaft so that the intake valves and exhaust valves of the cylinder under test are fully closed. Sealing a cylinder head outside of the engine may require that the head be mounted to a flat deck and gasket surface with a series of clamps. The probe is connected to a computer system or control unit containing pressure-sensing devices that measure the inlet and outlet pressures of an orifice of known geometry and dimensions. The cavity leak rate is a function of the orifice geometry and dimensions, the orifice inlet and outlet pressures, the ambient temperature, and the ambient pressure. The computer system determines the leakage rate and documents the test results in both printed and electronic formats.

### BRIEF DESCRIPTION OF THE DRAWINGS

Taking the following specifications in conjunction with the accompanying drawings will cause the invention to be better understood regarding these and other features and advantages. The specifications reference the annexed drawings wherein:

FIG. 1 is a perspective view of the apparatus with a cylinder head mounted thereon.

FIG. 2 is an enlarged perspective view of the apparatus's cylinder head clamping system with a test probe.

FIG. 3 is a perspective view analogous to FIG. 2 depicting an alternative embodiment of the cylinder head clamping system with a test probe.

FIG. 4 is an enlarged perspective view of a test probe.

FIG. 5 is a perspective view of an alternative embodiment of the apparatus showing an alternative embodiment of a test probe attached to a cylinder head port.

FIG. 6 is a pneumatic circuit diagram of the apparatus.

FIG. 7 is a typical test result of the apparatus display indicating cavity leakage as a percentage.

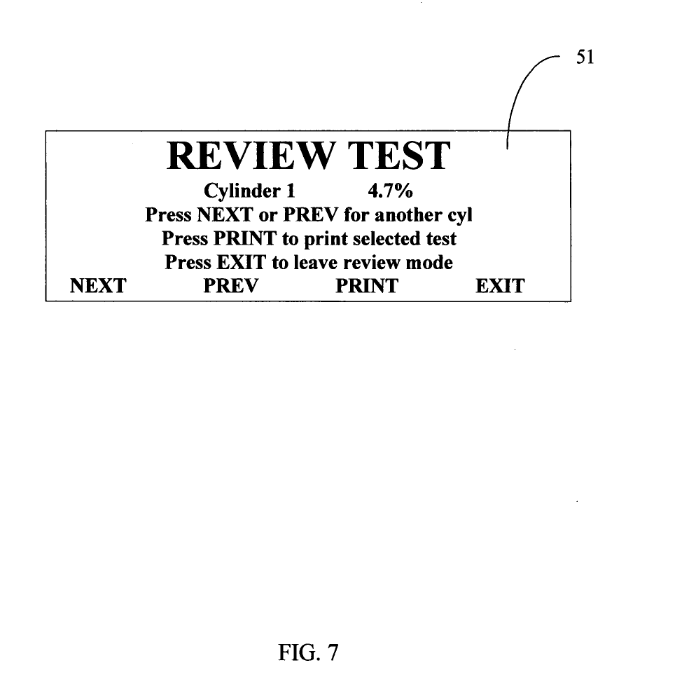

FIG. 8 is a typical test result of the apparatus display indicating cavity leakage as a rate.

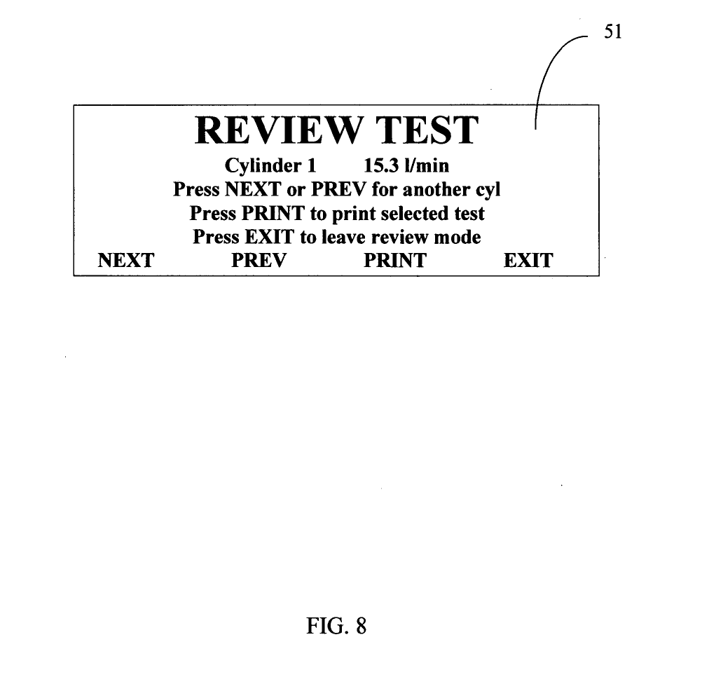

FIG. 9 is a typical documentation of the apparatus's leakage test of a four (4) cylinder head.

### DETAILED DESCRIPTION OF THE DRAWINGS AND PREFERRED EMBODIMENTS

While describing the invention and its embodiments, various terms will be used for the sake of clarity. These terms are intended to not only include the recited embodiments, but also all equivalents that perform substantially the same function, in substantially the same manner to achieve the same result.

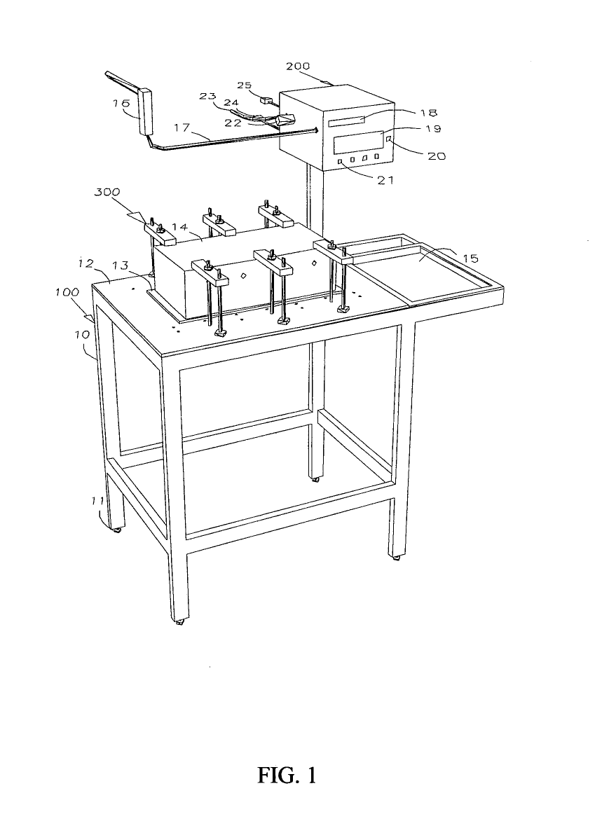

A preferred embodiment of the present invention discloses an apparatus for measuring cavity leakage depicted in a perspective view in FIG. 1 is comprised of, a workbench or test stand 100, with at least one supporting leg 10, with adjustable feet 11 that stabilize the workbench on uneven surfaces while leveling is not necessary, has a top plate 12 working surface and a tray 15 to hold small tools and other devices. A rubber-like or similar gasket 13 is sandwiched between the top plate 12 and the cylinder head 14 to be tested. Strap clamp assemblies 300 secure the cylinder head 14 to the top plate 12 with the cylinder head 14 orientated so that the smooth machined surface fire deck of the cylinder head is sealed to the gasket 13, preventing air leakage from within the cylinder head combustion chamber.

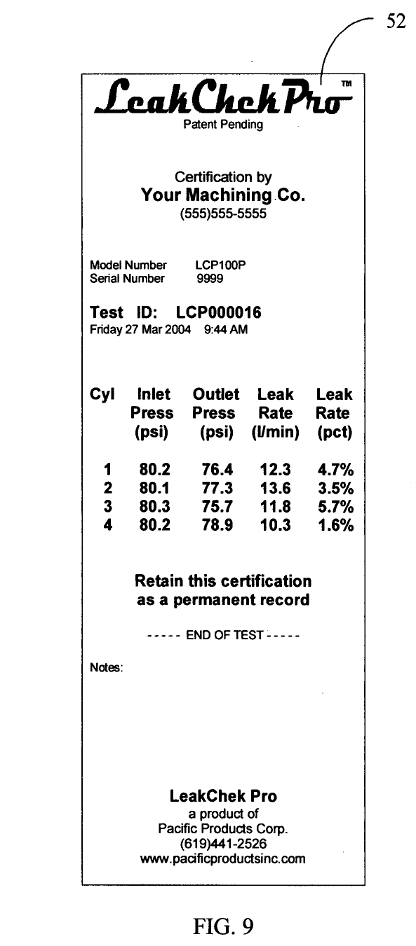

FIG. 1 also shows the computer system 200 which includes a display 19, a printer 18, softkey buttons 21, and a paper feed button 20. The display 19 presents softkey button legends above each softkey button 21 describing the function of that softkey, system information including status and configuration, prompts to the user in the use of the apparatus, and displays test results. The functions of the softkey buttons 21 change with the operational mode of the apparatus and provide user inputs to the computer system 200 to effect its operation. The printer 18 produces printed copies including test results, calibration coefficients, and system configuration or test results 52 depicted in FIG. 9. The paper feed button 20 causes the printer 18 to feed paper without printing. The computer system 200 can be battery powered or can receive electrical current from an alternating electrical current cable 25, accepts external positively or negatively pressurized air through the pressurized air source input 23. This pressurized air is directed to the test probe 16 through a hose or pipe and the pressurized air source output 17. The computer system 200 may have the ability to communicate with an external device such as a personal computer, a cell phone, a PDA and the like through an external data communication port 24, which could transmit data via a physical connection, or via infrared, radio, or cellular technology.

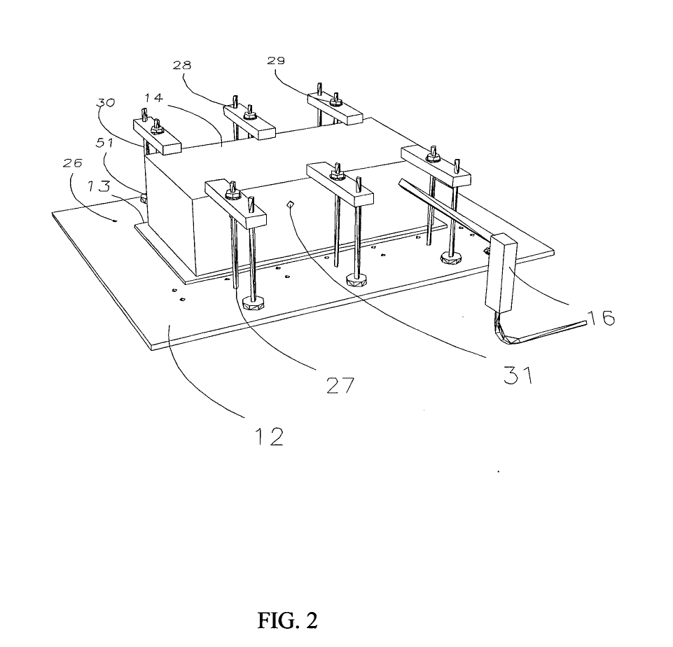

As shown in FIG. 2, the strap clamp assembly 300 is comprised of a strap clamp 28 including a threaded rod pivot 30 with a swivel foot 51 that rests on the top plate 12 and is adjusted to the correct height for the cylinder head under test so that the cylinder head 14 can be clamped firmly and provide a seal to the gasket 13 and the top plate 12. The top plate 12 has a plurality of threaded holes 26 dimensioned and positioned to accommodate the various different sizes and geometries of cylinder heads 14 or sealed cavities to be tested allowing the threaded clamping rods 27 to be secured or screwed into whichever of the top plate threaded holes 26 will position the strap clamp so that the cylinder head is sealed to the gasket. The clamping rod 27 also protrudes through a slot in the strap clamp 28 and a washer and clamping nut 29 are tightened to secure and seal the cylinder head 14 to the gasket 13 and to the top plate 12. Multiple strap clamp assemblies may be used to provide the desired clamping and sealing.

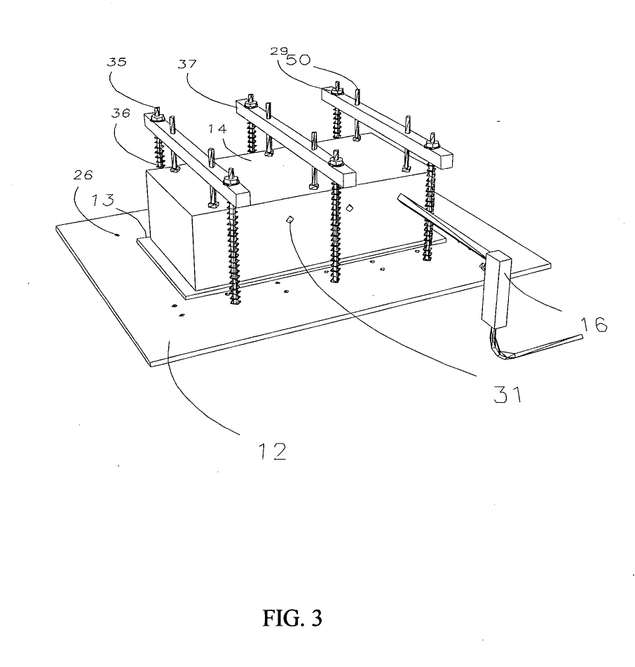

Alternatively, another embodiment as shown in FIG.3 teaches the use of at least one beam clamp 37 to seal the cylinder head 14 to the gasket 13. Multiple threaded clamping rods 35 are screwed into whichever of the top plate threaded holes 26 that best position a beam clamp 37 onto the cylinder head to firmly clamp and seal the cylinder head 14 to the gasket 13 and the top plate 12. The threaded clamping rods 35 protrude through the beam clamp 37, and compression springs 36 are located between the top plate 12 and the beam clamp 37 to support and suspend the beam clamp 37 a set distance greater than the vertical height of a cylinder head 14 to allow for easy placement of the cylinder head 14 when the clamping nuts 29 are loosened. Protruding from the beam clamp 37 and towards the top plate 12 is at least one beam standoff 50. When the cylinder head 14 is positioned on the gasket 13 the clamping nuts 29 are tightened which draws the beam clamp 37 towards the top plate 12 causing the beam standoff 50 to exert a normal force on the cylinder head 14 thus compressing the gasket 13 and sealing the cavity to be tested or in this case the cylinder head 14.

Alternatively, another embodiment teaches that when negatively pressurized air is used, the vacuum may create a self-sealing mechanism between the cylinder head and the gasket. In this case the clamp assemblies may not be necessary.

FIG. 2 depicts the test probe 16 inserted into a spark plug hole 31 to measure cylinder head leakage. In the case of a cylinder head with multiple spark plug holes, all holes other than the hole used by the test probe 16 must be sealed.

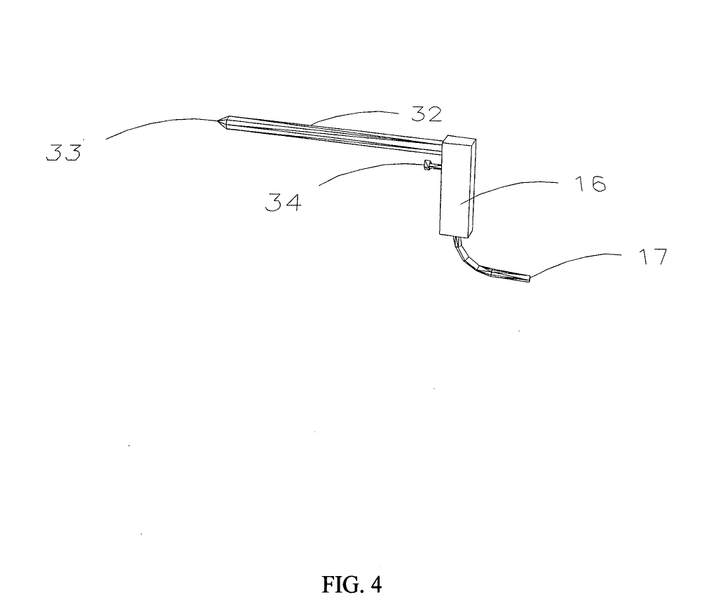

FIG. 4 shows the test probe detail including the extension tube 32 that allows the user to reach the spark plug hole 31 under test, the rubber-like test probe tip 33 that is cone-shaped and so seals the cylinder head spark plug hole 31 when pushed into it, and the test probe trigger 34 that controls the airflow through the test probe 16.

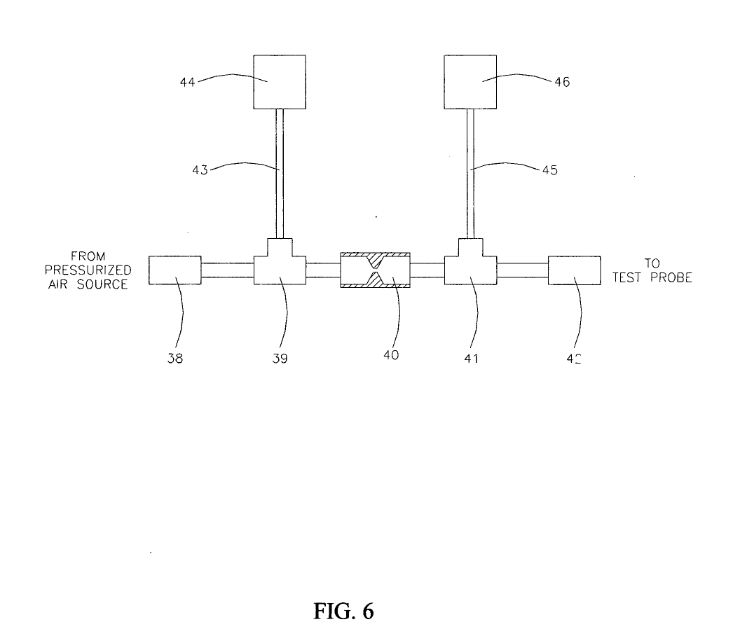

FIG. 6 shows the pneumatic circuit that includes the external positively or negatively pressurized air source connector 38, the outlet pressure manifold 41 and the inlet pressure manifold 39. Air flow branches from the inlet pressure manifold 39 to the inlet pressure transducer 44 through the inlet pressure connecting tube 43 and to the orifice 40 that has a known geometry and dimension. Air flow from the orifice 40 is branched between the outlet pressure manifold 41 to the outlet pressure transducer 46 through the outlet pressure connecting tube 45 and to the air source output connector 42.

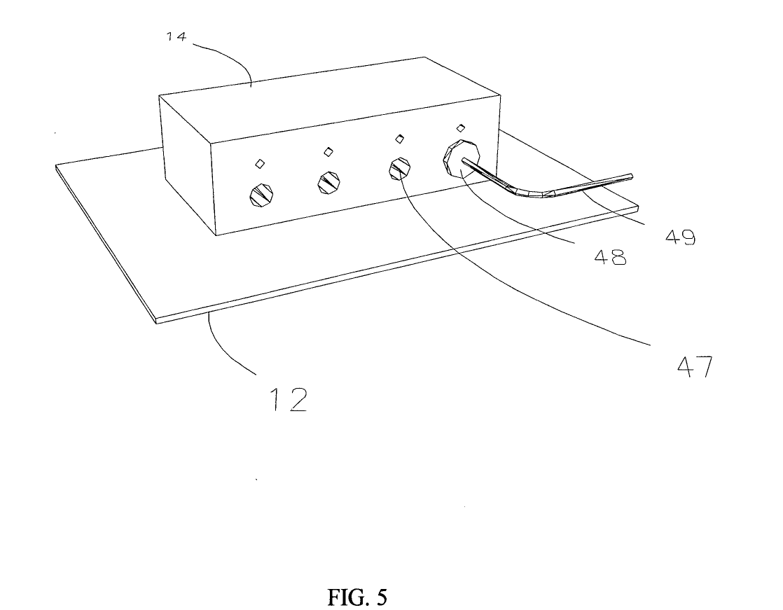

FIG. 5 likewise details an alternate embodiment of the leakage testing apparatus with the major difference being that the test probe 16 of FIG. 4 is replaced with a test probe 48 which can be formed from a rigid material with a seal of rubber-like or similar gasket material that is large enough to cover or enclose the area to be tested, for example if a circular exhaust valve is to be tested then the test probe 48 must have a larger diameter than the valve head. It is further contemplated that this test probe could be fashioned from a rigid semi-spherical vessel with an open and closed portion. The open portion has a gasket suitable for encircling and sealing the valve to be tested while the closed portion has an opening for the negatively pressurized air source. The negatively pressurized airsource pulls the test probe 48 against the cylinder head 14, providing a self-sealing mechanism and eliminating the need for additional clamping. Test areas include the ports, the combustion chamber and individual valves.

Viewing the components of FIG. 1, FIG. 4 and FIG. 6 will clarify the operation of the apparatus. For the sake of brevity the procedure will be disclosed utilizing positive air pressure: however, as disclosed earlier in the specifications it should be obvious that the operation is very similar regardless of the air pressure used. Once the cylinder head 14 is sealed to the gasket 13 by the strap clamp assembly 300, the computer system 200 prompts the user to insert the test probe 16 into the first cylinder to be tested. When the test probe trigger 34 is pressed, the computer system 200 senses the momentary outlet pressure drop as the cylinder fills through the outlet pressure transducer 46 and the inlet pressure transducer 44. After a delay, the processing unit measures the inlet pressure and outlet pressure and computes the pressure difference. The measuring sequence is repeated until the pressure difference is stable within acceptable limits. The computer system 200 computes and displays the cylinder leakage in the format selected by the user during the processing unit setup and configuration, prompts the user to remove the test probe 16, then prompts the user to accept the test results, retest the current cylinder, or abort the test sequence. When all cylinders have been tested the computer system 200 prompts the user to review the leakage for each cylinder, print the test results, or exit the test mode.

The apparatus may also be used on an assembled internal combustion engine or sealed cavity, in this instance test stand 100 and mounting peripherals are not used because the cavity or engine is intrinsically sealed. When testing an assembled engine the crankshaft must be positioned so that all valves of the cylinder under test are closed. The crankshaft must be fixed to prevent the piston from moving when air pressure is introduced into the cylinder. Leakage tests performed on assembled engines will account for valve leakage, piston ring leakage and cylinder head gasket leakage and can be displayed and printed in the same manner as in the preferred embodiment.

Orifice inlet pressure and outlet pressure are measured with air flowing through the orifice and leak. Mathematical formulas are applied using the orifice geometry and dimensions, inlet air pressure, and outlet air pressure to compute the flow rate through the orifice and the leak. The ratio of the inlet air pressure to the outlet air pressure determines which formulas are used. Normalization functions are then applied to provide accurate test data regardless of inlet air pressures. Absolute pressures are used for all computations. if,
InletPressure/OutletPressure>1.9 (sonic flow) (1)

$$Leak Rate ( 1 / min ) = \frac{k ⨯ Ft ⨯ InletPressure}{Lohms} \qquad ( 2 )$$

else,
InletPressure/OutletPressure<1.9 (subsonic flow) (3)

$$Leak Rate ( 1 / min ) = \begin{matrix}\frac{2 ⨯ k ⨯ Ft ⨯ \sqrt{( InletPressure - OutletPressure ) ⨯ OutletPressure}}{Lohms}\end{matrix} \qquad ( 4 )$$

where,

$$Lohms = \frac{0.76}{d \hat{} 2} \qquad ( 5 )$$

d=orifice diameter in inches (6)
k=271 (7)
Ft=1.00 (at standard temperature and pressure) (8)

A temperature-measuring sensor can be used to improve the accuracy of the measurement at non-standard temperatures. The equation used to compute Ft is then:

$$Ft = \sqrt{\frac{Ta + t 1}{Ta + t 2}} \qquad ( 9 )$$

where,
Ta=460° F. (10)
T2=measured temperature (11)
T2=59° F. (standard temperature) (12)

Standard pressure at standard temperature can be used in the computations. It is contemplated that in further embodiments a pressure transducer can be used to improve the accuracy of the measurement at non-standard pressures and temperatures.

The flow through the orifice and the leak are equal and using the equations (1) through (12) above the effective leak diameter can be computed regardless of the air pressures used during the measurement. The leakage rates are normalized to any desired inlet pressure by computing the intermediate pressure between the orifice and the leak using the desired inlet pressure, the ambient pressure, and the effective leak diameter. The desired inlet pressure, the intermediate pressure and the ambient pressure are used to compute the leakage as a percent or as a rate, such as l/min, using equations (13) through (17) below.
Leak Rate (percent)=InletPressure−IntermediatePressure/InletPressure (13)
if,
IntermediatePressure/AmbientPressure>1.9 (sonic flow) (14)

$$Leak Rate ( 1 / min ) = \frac{k ⨯ Ft ⨯ InletPressure}{Lohms} \qquad ( 15 )$$

else,
IntermediatePressure/AmbientPressure<1.9 (subsonic flow) (16)

$$Leak Rate ( 1 / min ) = \begin{matrix}\frac{2 ⨯ k ⨯ Ft ⨯ \sqrt{\begin{matrix}InletPressure - IntermediatePressure ) ⨯ \\ IntermediatePressure\end{matrix}}}{Lohms}\end{matrix} \qquad ( 17 )$$

The computer system 200 allows the user to self-test the unit, calibrate the pressure transducers, set and maintain the current date and time, set the user name and phone number, set the transaction identification for display and printing, store test results, retrieve previous test results for display and printing, verify the integrity of the stored test results, and erase the stored test results.

The computer system 200 allows the user to select the leakage rate format, select the number of cavities to test, select the cavity test location such as a port or a valve or the combustion chamber, repeat the previous test, display the test results, print the test results, and abort the test sequence.

The invention has been described in terms of the preferred embodiment. One skilled in the art will recognize that it would be possible to construct the elements of the present invention from a variety of means and to modify the placement of the components in a variety of ways. While the embodiments of the invention have been described in detail and shown in the accompanying drawings, it will be evident that various further modifications are possible without departing from the scope of the invention as set forth in the following claims.

What is claimed is:

1. Apparatus for testing cavities for fluid leakage with positively or negatively pressurized air comprising:
(a) test probe;
(b) means for sealing said cavity;
(c) inlet pressure meter;
(d) orifice of known geometry and dimensions;
(e) outlet pressure meter;
(f) means to compute the cavity leakage rate by measuring the air flow rate through said orifice;
(g) means to print and store data.

2. The apparatus of claim 1, wherein the test probe comprises a flexible conical tip suitable for insertion and sealing a spark plug opening with an extended cylindrical probe extension tube terminating into a handle-like structure with a switch for positively or negatively pressurizing the cavity to be tested.

3. The apparatus of claim 1, wherein the test probe comprises a semi-flexible plunger-like fitting suitable for encircling the perimeter and forming an air-tight seal on a spark plug opening, intake valve, exhaust valve, or similar opening when positive or negative pressure is introduced to said fitting.

4. The apparatus of claim 1, wherein the test probe comprises a rigid semi-spherical fitting having an open and closed end said closed end having a penetration to allow air flow into said fitting with said open end having a gasket forming material of suitable diameter for encircling the perimeter and forming an air-tight seal on a spark plug opening, intake valve, exhaust valve, or similar opening when positive or negative pressure is introduced to said fitting through said penetration.

5. The apparatus of claim 1, wherein the means to seal the cavity having an open end and an opposing closed end comprises a clamping device that sandwiches a gasket between the open end surface of the cavity to be tested and the top plate of a test stand parallel to said open end surface utilizing a plurality of threaded clamping rods with two threaded ends mounted perpendicular to said top plate at one end with the closed end of said clamping rod connected to a beam member exerting a normal force on the closed end surface of the cavity.

6. The apparatus of claim 1, wherein outlet and inlet pressure meters comprise pressure transducers that convert pressure measurement into electronic impulses.

7. The apparatus of claim 1, wherein the means to compute and store data is a computer.

8. The apparatus of claim 5, wherein the test stand comprises: at least one adjustable vertical leg to accommodate uneven surfaces, a horizontal platform or top plate suitable for supporting cavity to be tested with a recessed reservoir suitable for containing tools or parts, and a cavity clamping structure.

9. The apparatus of claim 1, wherein the orifice comprises a cylindrical pipe structure with an inlet and outlet separated by an internal baffle that has a relatively small opening to allow fluid flow between said inlet and said outlet through said baffle.

10. The apparatus of claim 1, wherein the means to compute the cavity leakage rate comprises: means to select leakage rate format; means to self-test the processing unit; means to calibrate processing unit; means to select number of cavities to test; means to measure pressure on both the orifice inlet and orifice outlet; means to compute the pressure difference; means to compute leakage rate in various formats; means to normalize test results with varying test pressures; means to display test results; means to store test results; means to print test results; means to verify the integrity of stored test results; means to remove stored test results; means to transmit test data to other devices; means to repeat previous test; means to maintain current time and date; means to enter current time and date, user information, and transaction information; and means to easily insert printer paper.

11. A cylinder head testing device comprising:
(a) test stand supported by at least one leg having at least one foot to level said stand and a horizontal flat platform or table top with a plurality of threaded through holes that may accept at least one threaded clamping rod to sandwich a gasket between the cylinder head and said table top forming a sealed cavity;
(b) a test probe with a flexible conical tip suitable for insertion into the spark plug hole of said cylinder head to form an airtight seal;
(c) an outlet pressure transducer connected between the test probe and a cylindrical chamber divided by an orifice of known dimension;
(d) said orifice further connected to an inlet pressure transducer;
(e) said inlet pressure transducer further connected to a positively or negatively pressurized air source; and
(f) a processing unit connected to each of said transducers capable of calculating, storing, and printing the cylinder leakage rate of said cylinder head.

12. (canceled)

13. (canceled)

14. A method for detecting and computing the leakage rate of a sealed chamber utilizing a computational device, comprising:
(a) measuring the flow rate of a positively or negatively pressurized fluid through an orifice of known geometry and dimensions in series with the sealed chamber;
(b) computing leakage rate as a flow rate or percent leakage;
(c) using a normalizing function to provide accurate and consistent data at any flow rate or pressure.

15. The method of claim 14, wherein said flow rate is either sonic or subsonic.

16. The method of claim 14, wherein said computational device is a computer.

17. The method of claim 14, wherein said data is permanently recorded.
